(19) United States
(12) Patent Application Publication
(10) Pub. No.: US 2007/0143968 A1
(43) Pub. Date: Jun. 28, 2007

(54) Comfortable handle

(76) Inventor: Shu-Chuan Tseng, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/318,857

(22) Filed: Dec. 28, 2005

(51) Int. Cl. B25G 1/10

(52) U.S. Cl. 16/430

(57) ABSTRACT

The invention relates to a comfortable handle, which includes a central rod connecting with a soft shell and liquid therein. A top cap and a bottom base can be connected with the central rod to engage the soft shell firmly at the same time. Thus, the handle can be assembled very easy and simple and then can be applied on products for comfortable use to increase the utilization.

### BACKGROUND OF THE INVENTION

For comfortable use, a handle being provided with a soft skin is applied on many products. There is an improved handle, which includes a central rod and a soft shell. And between the rod and shell, liquid is injected therein to increase the soft feeling. In such designs, they although provide a soft handle for comfortable use but the structure of them are very complex that they need many parts to be assembled in trouble details. It is still lack of utility.

The present invention is to provide a new comfortable handle, which has a very simple structure to be easily assembled and will be a useful soft one for comfortable application. Now, accompanying with the following drawings, the character of the present invention will be described here and after.

### BRIEF DESCRIPTION OF THE DRAWINGS

FIG. 1 is a perspective view showing a comfortable handle according to the present invention.

FIG. 2 is an exploded perspective view of FIG. 1.

FIG. 3 is a first cross-sectional plan view of FIG. 1.

FIG. 4 is a second cross-sectional plan view of FIG. 1.

FIG. 5 is a third cross-sectional plan view of FIG. 1.

FIG. 6 is a plan view showing an application of the comfortable handle according to the present invention.

### DETAILED DESCRIPTION OF THE PREFERRED EMBODIMENT

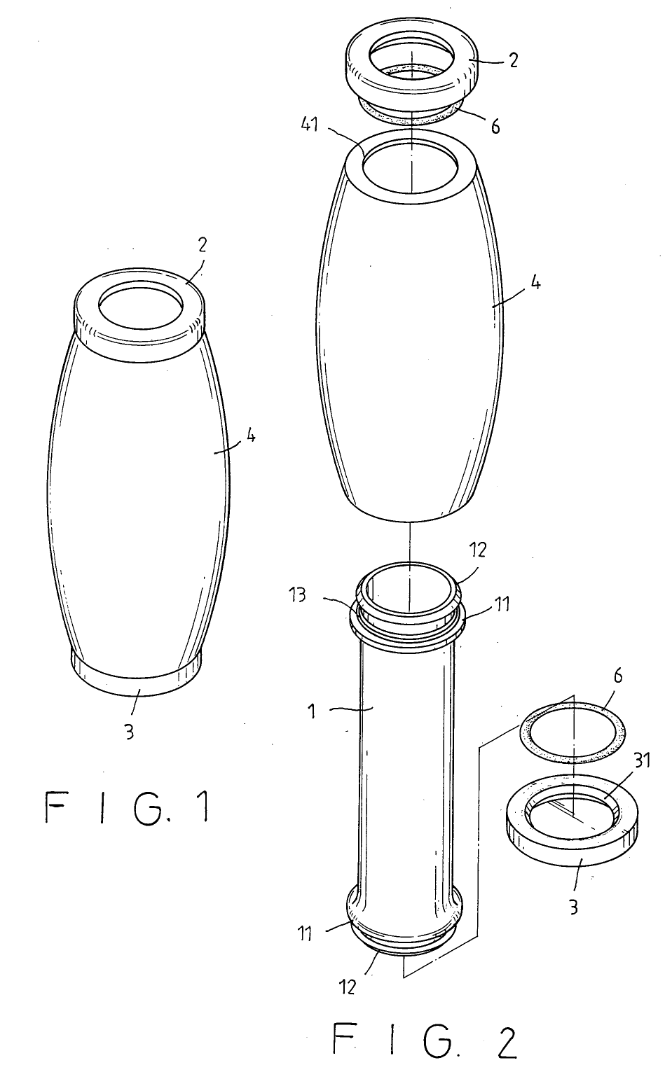

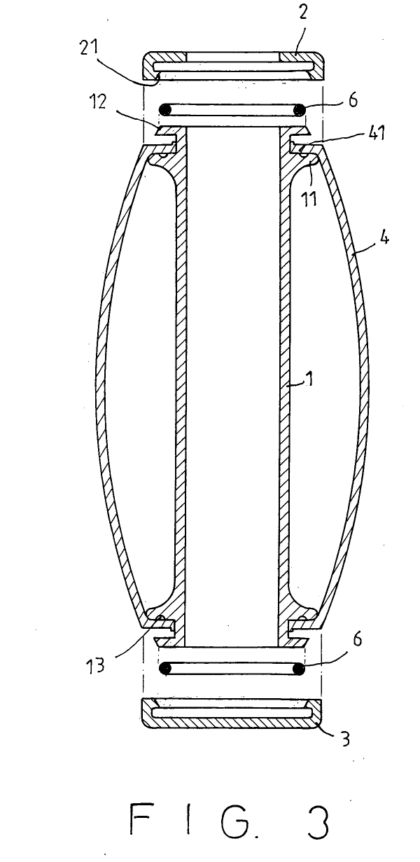

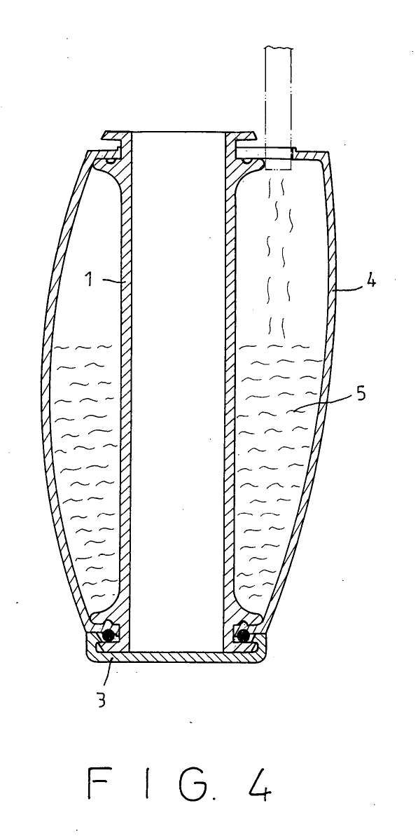

Referring to FIG. 1 to 5, the present invention includes a central rod (1), an upper cap (2), a bottom base (3), and a soft shell (4). The central rod (1) has its both ends a support flange (11) and an engaging flange (12), wherein at outer surface of the support flange (11), an annual groove (13) is provided. The soft shell (4) provided outside the central rod (1) has its two inner rims (41) cover the support flanges (11) respectively. The upper cap (2) has a reversed hook (21) to connect with the upper engaging flange (12) and the bottom base (3) has a reversed hook (31) to connect with the lower engaging flange (12) of the central rod (1), while washers (6) are provided therebetween. Under such connection, the washer (6) will press part of the inner rim (41) received in the annual groove (13) of the support flange (11) that completes a secure connection of all means.

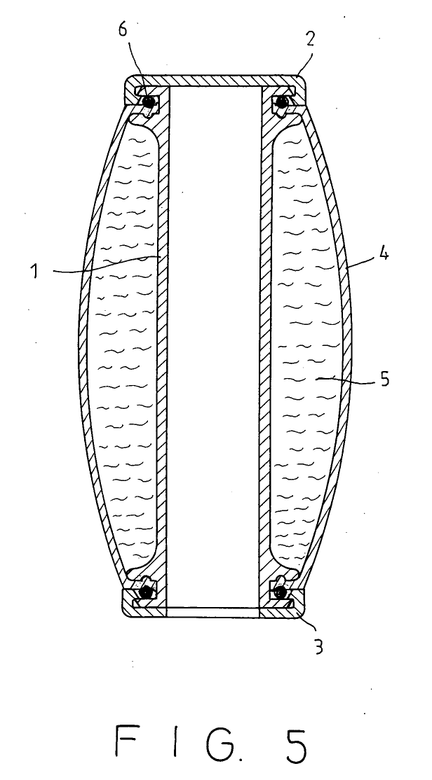

In assembly, the bottom base (3) is connected first. Then, to pull upper end of the soft shell (4), as shown in FIG. 4, to inject liquid (5) therein and to put the soft shell (4) back. After connection with the top cap (2), shown in FIG. 5, the comfortable handle is therefore completed. Since the connection with the top cap (2) and the bottom base (3) is very simple and the injection of liquid within the soft shell is still easy, the present invention obtains the predicted purpose.

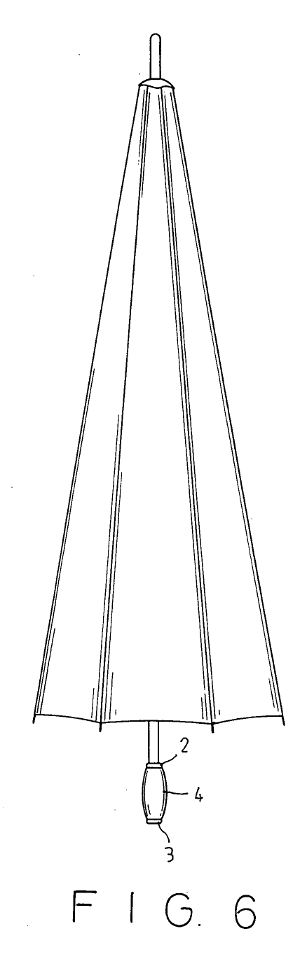

Referring to FIG. 6, it shows an application of the present invention on an umbrella. It is also to be understood that the application is only exemplary, which can be applied on any suitable products. Any modification with the same or similar merit is still claimed in this application.

I claim:

1. A comfortable handle including a central rod, an upper cap, a bottom base, and a soft shell, wherein the central rod has its both ends a support flange and an engaging flange and at outer surface of the support flange, an annual groove is provided, the soft shell provided outside the central rod having its two inner rims cover the support flanges respectively, the upper cap having a reversed hook to connect with the upper engaging flange and the bottom base having a reversed hook to connect with the lower engaging flange of the central rod, while liquid is injected within the soft shell and washers are provided between the flanges to press part of the inner rim received in the annual groove of the support flange that completes a secure connection of all parts.
